(19) United States
(12) Patent Application Publication
(10) Pub. No.: US 2009/0175182 A1
(43) Pub. Date: Jul. 9, 2009

(54) Differentiated service transmission parameters adaptation

(75) Inventors: Hui Shen, Sammamish, WA (US); Jiandong Ruan, Sammamish, WA (US); Kun Tan, Beijing (CN); Jiansong Zhang, Beijing (CN); Amer A. Hassan, Kirkland, WA (US); Bernard D. Aboba, Bellevue, WA (US); Yi Lu, Sammamish, WA (US); Tong Zhou, Durham, NC (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/006,864

(22) Filed: Jan. 7, 2008

(51) Int. Cl. G06F 11/30

(52) U.S. Cl. 370/252

(57) ABSTRACT

Systems and methods are provided for transmitting data on a wireless network. Some embodiments provide a technique whereby a type is determined for the transmission, at least one metric is determined for the transmission based at least in part on the transmission type and/or an indication of conditions on the channel on which the transmission is to be performed, at least one transmission parameter to be used in performing the transmission is selected to optimize the at least one metric, and the data is transmitted in accordance with the at least one transmission parameter.

### FIELD OF THE INVENTION

This invention relates to wireless networks, and more particularly to performing data transmission over wireless networks.

### BACKGROUND OF THE INVENTION

In a wireless network, whether data can be successfully transmitted from a sender to a receiver (either of which may include, as examples, a wireless device such as a personal computer, personal digital assistant, cellular telephone, etc., or a wireless access point) is determined by several factors, including the conditions of the channel on which transmission is attempted, the transmission power of the sender, the rate at which the sender transmits the data, and/or other factors. Some of these factors can be managed or controlled by the sender, but others can not. For example, channel conditions (noise, interference, etc.) may be affected by factors that vary over time and location, and thus are largely beyond the control of the sender. If some channel conditions are not ideal, a transmission may fail.

The rate at which data is transmitted is one factor which the sender can control, and the sender may adjust the data transmission rate to try to account for the other factor(s) affecting connectivity to improve the successful data delivery rate. However, this does not always help. For example, lowering the transmission rate may effectively deal with some problems (e.g., reducing packet error rates over the channel), but if other problems exist (e.g., the presence of a strong interference), then lowering the transmission rate may actually make it more likely that the transmission will fail. For example, because lowering the transmission rate means that it takes longer to complete a given transmission, if the other factor(s) include interference (e.g., caused by a microwave oven or cordless phone) that occurs in a spike, then lowering the transmission rate may make it more likely that interference occurs during the transmission.

### SUMMARY OF THE INVENTION

In accordance with some embodiments of the invention, a technique is provided for improving wireless network connectivity that includes adjusting one or more transmission parameters (e.g., data transmission rate and/or other parameters discussed below) based on factors such as channel conditions (e.g., background noise on the channel, interference, etc.). For example, in some embodiments, a transmission parameter adaptation algorithm is provided that provides for determining channel conditions and dynamically selecting transmission parameters based on those conditions. In some embodiments, the channel conditions that may affect a transmission are consistently monitored, so that transmission parameters may be dynamically adapted to maximize connectivity over the network.

In some embodiments, parameters may be selected based at least in part on the type of transmission. For example, if a transmission is being performed to transfer a file, then transmission parameters may be selected to (as an example) maximize the throughput of the transmission, but if the transmission includes Voice over Internet Protocol (VoIP) data, then transmission parameters may be selected to (as an example) ensure a high packet delivery ratio and low delay plus jitter. Transmission parameters types of transmission, in embodiments of the invention, may tailor each transmission to optimize one or more chosen metrics for the transmission type, and may account for channel conditions in doing so. In this respect, conventional transmission adaptation mechanisms do not differentiate based on transmission type, but rather employ a single algorithm to determine the appropriate transmission rate regardless of transmission type. By selecting transmission parameters based at least in part on the transmission type, embodiments of the invention may optimize chosen metrics to deal with the issues that are specific to different transmission types.

### BRIEF DESCRIPTION OF THE DRAWINGS

FIG. 1 is a flowchart depicting an example process for adaptively transmitting data on a wireless network based on the transmission type, in accordance with some embodiments of the invention;

FIG. 2 is a flowchart depicting an example process for adaptively transmitting data on a wireless network based on channel conditions, in accordance with some embodiments of the invention;

FIG. 3 is a conceptual illustration of an example environment table employed by some embodiments of the invention;

FIG. 4 is a conceptual illustration of an example technique for estimating a transmission metric value, in accordance with some embodiments of the invention;

FIGS. 5A-5B are graphs depicting an example technique for estimating a transmission metric value, in accordance with some embodiments of the invention;

FIG. 6 is a block diagram depicting example components of a system for implementing aspects of the invention;

FIG. 7 is a block diagram depicting an example computer which may be used to implement aspects of the invention; and

FIG. 8 is a block diagram depicting an example computer memory on which instructions implementing aspects of the invention may be recorded.

### DETAILED DESCRIPTION OF THE INVENTION

Some embodiments of the invention provide a technique for transmitting data on a wireless network which includes determining one or more factors, such as the channel conditions, selecting one or transmission parameters to account for the channel conditions, and transmitting the data according to the parameter(s). For example, some embodiments of the invention provide an algorithm which takes as input the channel conditions, and provides as output transmission parameters which may then be applied to a transmission to achieve network performance goals. The algorithm may, for example, be employed by a device configured for communication via a wireless network (a personal computer, personal digital assistant (PDA), cellular telephone, wireless access point, etc.) so that the device may transmit data on a wireless network in accordance with the parameters.

Some embodiments may select one or more transmission parameters based at least in part on the transmission type, so as to optimize one or more chosen metrics for the considered transmission type. Further, the transmission parameters may be chosen to account for channel conditions. As a result of selecting transmission parameters based on the transmission type, embodiments of the invention may optimize one or more metrics to address issues specific to particular transmission types.

The sections that follow first describe an example technique for selecting transmission parameters so as to optimize one or more metrics for a transmission type, and then an example technique for selecting transmission parameters based at least in part on channel conditions. An example system is then described for transmitting data on a wireless network in accordance with one or more transmission parameters selected according to the transmission type and/or channel conditions.

### I. Selecting Transmission Parameters Using Transmission Type

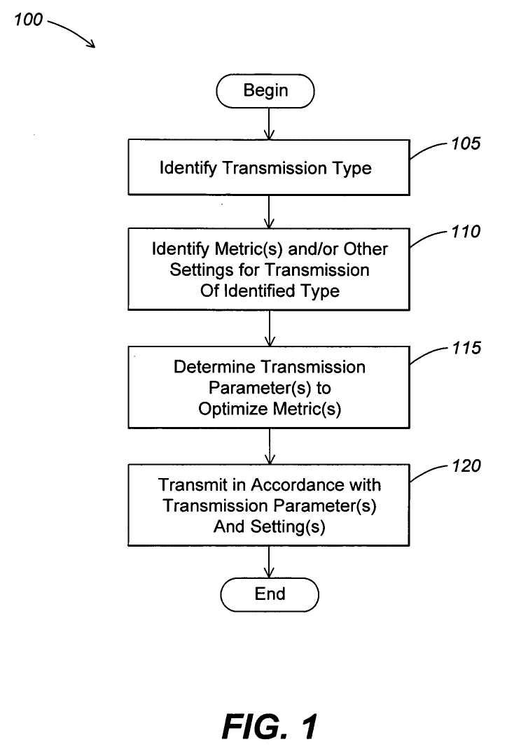

An example process 100 for determining transmission parameters based on transmission type, and applying those parameters to a wireless network transmission, is shown in FIG. 1.

Process 100 begins with act 105, wherein the type for a particular transmission is identified. Transmission types may be identified in any of numerous ways, and embodiments of the invention are not limited to any particular implementation. In some embodiments, a transmission type may be identified using various indicators and/or characteristics of a transmission as reflected in the data comprising the transmission. In this respect, those skilled in the art will recognize that network transmissions generally adhere to the Open Systems Interconnection (OSI) seven-layer model, wherein each layer provides functions that provide services to the layer above and receive services from the layer below. The seven layers of the model (termed the “network stack”) include application, presentation, session, transport, network, data link, and physical layers. In some embodiments of the invention, various indicators provided in one or more of these layers may be used to identify a particular transmission type.

Any of numerous indicators, or combinations thereof, may be used to identify a particular transmission type. For example, some embodiments identify the transmission type using indicators provided in the data link layer (i.e., layer 2 of the network stack). For example, a VoIP transmission may be identified using either the 802.1 “quality of service” tagging field, or the WiFi multimedia priority queue. A 802.1x or WiFi Protected Access 2 (WPA2) transmission may be identified using the Ethertype indicator found in the layer 2 header. The packet header may be used to identify unicast and/or multicast transmissions. Of course, embodiments of the invention are not limited to identifying transmission type using these indicators, as other indicators provided in this and/or other network layers, and/or any other proprietary or non-proprietary marking mechanism(s), or a combination thereof, may alternatively be used. The invention is not limited to any particular implementation.

At the completion of act 105, process 100 proceeds to act 110, wherein the metric(s) and/or other transmission settings for the identified transmission type are determined. That is, now that the transmission type has been identified, the metric(s) to be optimized for that transmission type, as well as any other settings to be used in the transmission, are determined.

Table 1 below lists some common transmission types and examples of metrics and transmission settings. Of course, different or additional metrics and/or settings may be employed for any of the listed (or other) transmission types, as the invention is not limited to any particular implementation.

TABLE 1

| Transmission | Desired Transmission | | |
|---|---|---|---|
| Type | Qualities | Metric | Other Transmission Settings |
| 802.1x | High packet delivery ratio. | Frame delivery ratio | Set retry count to maximum to |
| | | (FDR). | ensure delivery. |
| VoIP | High packet delivery ratio | FDR | Set retry count to small value to |
| | and low jitter. | | reduce jitter. |
| File transfer | High throughput. | Throughput = FDR × expected | N/A. |
| | | effective | |
| | | rate. | |
| UDP Streaming | For normal packets: high | For normal packets: | For normal packets: set retry count |
| Media | packet delivery ratio and | FDR × sgn | to smaller value to lower jitter. |
| | low jitter with guaranteed | (throughput − throughput_{threshold}); | For key packets: set retry count to |
| | throughput. | For key packets: | larger value to improve delivery |
| | For key packets: high | FDR. | ratio. |
| | packet delivery ratio. | | |
| Multicast and | High reliability. | FDR | If allowed, set retry count to larger |
| Broadcast | | | value to improve delivery ratio. Use |
| packets | | | more reliable forward error |
| | | | correction (FEC) code to better |
| | | | recover from errors. |

In Table 1, the “Metric” column defines an example metric to be optimized for the corresponding transmission type. For example, for 802.1x traffic, the desire is to optimize FDR. The “Other Transmission Settings” column defines other settings to be employed for a transmission of this type. For example, with an 802.1x transmission, the retry count for the transmission is set to maximum, in an attempt to maximize the packet delivery ratio. By contrast, with a VoIP transmission, the intent is to maximize packet delivery while minimizing jitter, so the retry count is set to a smaller value.

In Table 1, the metric for the “file transfer” transmission type is throughput, which is calculated by multiplying FDR by the “expected effective rate.” The expected effective rate is a measure of the maximum amount of effective data (excluding frame transmission overhead) per unit time. For different wireless technologies, different methods may be used to estimate the expected effective rate. In 802.11 networks, wherein transmission overhead includes channel acquire time, physical layer convergence procedure (PLCP), preamble, etc, the following equation may be used to estimate the effective data rate:

$$Effective data rate = \frac{PacketSize}{Time of ( \begin{matrix}Average channel acquire + \\ PLCP + preamble\end{matrix} ) + \frac{8 \times Packet Size}{Data Rate}}$$

Other techniques (e.g., other equations) may be employed to estimate the effective data rate for this and other wireless technologies, as the invention is not limited to being implemented in any particular manner.

At the completion of act 110, process 100 proceeds to act 115, wherein the transmission parameter(s) is (are) selected to optimize the metric(s) for the considered transmission type. As described in detail in Section II, in some embodiments, the transmission parameter(s) is (are) selected in a manner which accounts for channel conditions. For example, if the metric to be optimized for a particular transmission type is frame delivery ratio, then one or more transmission parameters may be selected which will maximize FDR given the channel conditions. For example, if it is known based on observed channel conditions, or it can be estimated (using any of numerous techniques, some of which are described below) that a first data transmission rate (e.g., 36 Mbps) will yield a higher FDR than a second data transmission rate (e.g., 54 Mbps), then the first data transmission rate may be selected as one of the transmission parameters in order to maximize FDR. Of course, transmission parameters may be selected in any of numerous ways, some of which may not account for channel conditions, or may do so in ways different than in the manner described herein. Embodiments of the invention may be implemented in any of numerous ways.

Process 100 then proceeds to act 120, wherein data is transmitted in accordance with the transmission parameter(s) determined in act 115 and any other transmission setting(s). Continuing with the example above, if the data to be transmitted is VoIP traffic (such that FDR may be maximized), the data may be transmitted at a rate of 36 Mbps (i.e., the rate which is known or estimated to yield the highest FDR), and the retry count for the transmission may be set to a low value (as defined above in Table 1) so as to minimize the jitter for the transmission.

At the completion of act 120, process 100 completes.

Section II below describes in detail an example technique for determining the transmission parameter(s) for a particular transmission.

### II. Transmission Parameter Selection

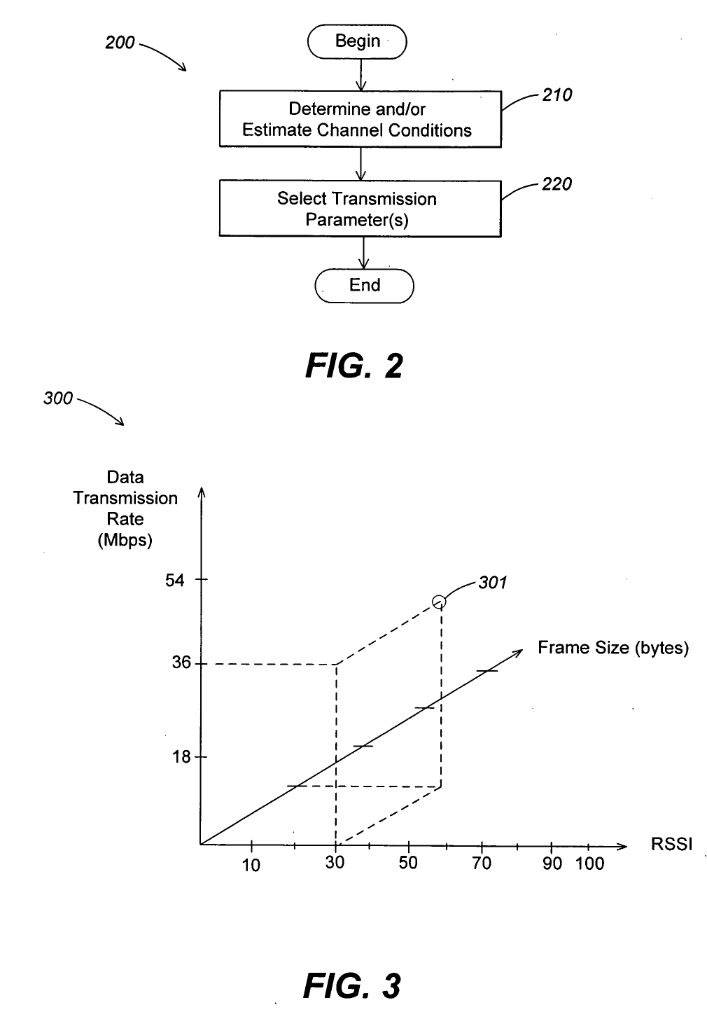

In accordance with some embodiments of the invention, the parameter(s) for a particular transmission are selected using an indication of channel conditions. An example process 200 for selecting one or more parameters based at least in part on channel conditions is shown in FIG. 2. Process 200 may, for example, be performed in act 115 of process 100 (FIG. 1), although the invention is not limited to such an implementation.

At the start of process 200, in act 210, one or more channel conditions are determined and/or estimated. This may be performed in any of numerous ways. In some embodiments, channel conditions may be determined and/or estimated by monitoring transmission history and, based on historical data, constructing an “environment table” which describes the transmission environment along several dimensions. Data stored in the table may be the result of observed conditions, or estimates (e.g., based the observed conditions and/or other factors). The environment table may then be employed to select the parameter(s) for a particular transmission. For example, if the goal is to optimize a particular metric (e.g., FDR) for a transmission type (e.g., a multicast packet), then one or more transmission parameters (e.g., a transmission rate) which are known or can be estimated to optimize this metric may be selected. In some embodiments, the environment table may be continually updated using observations relating to the success or failure of each delivery attempt, so that updated information may be used to select the parameter(s) for subsequent transmissions.

FIG. 3 conceptually illustrates an example environment table 300. In this example, table 300 stores data along three dimensions, including receiver signal strength indication (RSSI), data transmission rate and frame size dimensions, and is thus capable of representation as a Cartesian system in which coordinates on each axis correspond to dimension values. In the example shown, RSSI is represented along the x axis, data transmission rate along the y axis and frame size along the z axis, although the invention is not limited to such an implementation. In this respect, any indication of channel conditions may be stored or represented in an environment table, and the table (or an equivalent thereof) may store or represent data along any number of dimensions. In the example table 300 shown, each cell in the table stores an observed or estimated FDR for the channel conditions defined by a given RSSI, data transmission rate and frame size. For example, in the example shown, cell 301 stores an observed or estimated FDR for an RSSI of “30,” a data transmission rate of “36 Mbps” and a frame size of “0-100 bytes.” Of course, FDR need not be used as a metric, as any suitable indication(s) may be employed. The invention is not limited in this respect.

The RSSI values represented on the x axis in this example may, in some embodiments, be an indication of signal strength at a receiver site. In the example shown, RSSI is represented as a normalized value from zero to one hundred in increments of ten. The data transmission rate, represented on the y axis is, in this example, measured in megabits per second (Mbps), defined at certain transmission rate increments. Specifically, in the example shown, the data transmission rate is defined in increments of eighteen megabits per second, such that table 200 includes intervals at eighteen megabits per second, thirty-six megabits per second, fifty-four megabits per second, etc. The frame size represented on the z axis is, in this example, categorized using frame size ranges. In the example shown, one frame size category is for frames less than one hundred bytes in size, another is for frames between one hundred and five hundred bytes, another is for frames between five hundred and one thousand bytes, and another is for frames greater than one thousand bytes. Of course, any indicators may be employed, may be represented in any fashion (e.g., normalized values and categories may, but need not, be employed), and desired level of granularity may be represented on any dimension. Those skilled in the art may envision numerous variations on the example environment table, and the invention is not limited to any particular implementation.

The values populating environment table 300 may be obtained in any suitable fashion. For example, values may be based on observations from previous data transmissions. For example, values in table 300 may be constructed by storing an indication of the success or failure of each transmission for every RSSI, data transmission rate and frame size increment, and calculating FDR by dividing the number of successfully transmitted frames by the number of transmitted frames for each. For example, in some embodiments, a wireless device may maintain a buffer storing an indication of the success or failure of each transmission during a predefined interval t_{buffer} for each RSSI, data transmission rate and frame size increment, and this information may be used to calculate the FDR for the interval. The interval t_{buffer} may be a predefined timeout value, the time required to send a predefined number of frames, one or more other intervals, or a combination thereof. Data stored in buffers may be managed in various ways, such as by clearing each buffer at the beginning of each interval, maintaining the interval as a sliding window, or using any other suitable technique.

In some embodiments, because each buffer may store information for a given interval, there may be no current measurement(s) from which to calculate FDR. For example, if no frames have been transmitted during an interval, there may be no values from which FDR can be determined. In such cases, FDR (or information from which FDR may be calculated or derived) may be estimated.

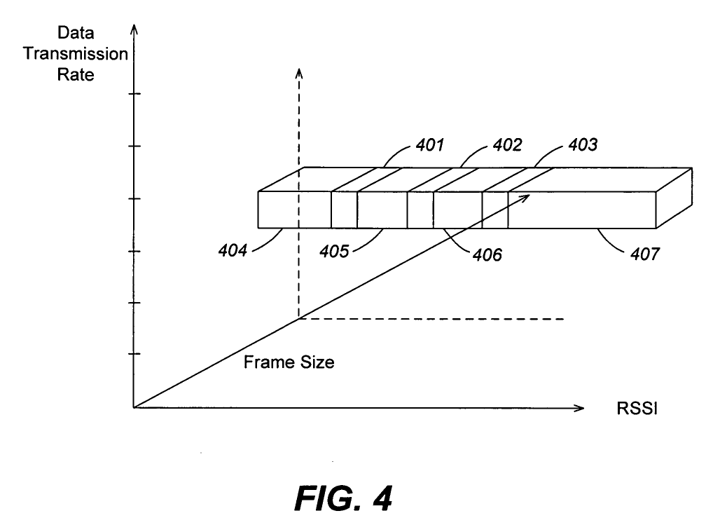

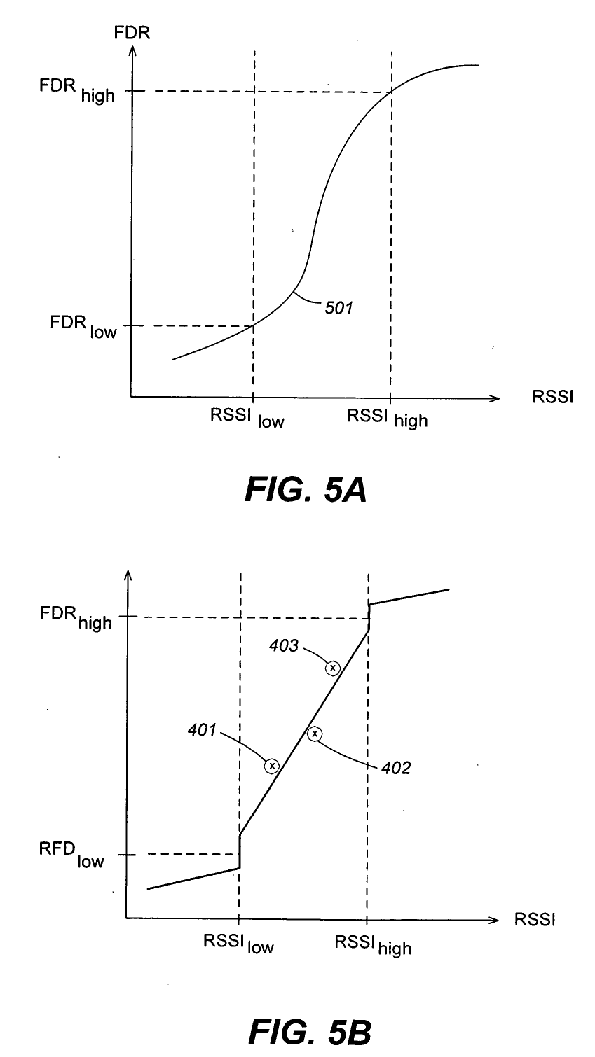

One technique for estimating FDR, illustrated in FIGS. 4 and 5A-5B, employs a fitting algorithm. Specifically, this technique assumes that for a certain data transmission rate and frame size, measured FDR values for a collection of RSSI's are [(FDR₁, RSSI₁), (FDR₂, RSSI₂), . . . , (FDRₙ, RSSIₙ)], and employs the measured FDR values to estimate FDR for all RSSI values for the same data rate and frame size S. This is illustrated conceptually in FIG. 4, in which measured FDR values 401-403 may be used to measure the remaining FDR values 404-407 for RSSIs at a given data transmission rate and frame size. In some embodiments, the technique employs a fitting algorithm. The algorithm may, for example, consider factors such as known relationships between data transmissions and channel conditions based on the nature of wireless technology, and/or different system requirements, such as computational overhead, accuracy and memory usage.

For example, the theoretical relationship between FDR and RSSI in a WiFi network is depicted in FIG. 5A. In FIG. 5A, curve 501 has a large slope where RSSI is within a certain range (in this example, between RSSI₁₀, and RSSI_{high}). For RSSI values greater than RSSI_{high}, FDR saturates and can not increase as RSSI increases. For RSSI values less than RSSI_{low}, FDR is close to zero. Using this theoretical relationship, a least-square linear algorithm can be used to estimate FDR at various RSSI values. That is, FDR can be estimated if the range of RSSI in which the curve has a large slope, and the FDR values at the turning points of the curve (i.e., at FDR_{low}, and FDR_{high} in FIG. 5A), are known.

In some embodiments, ten percent and seventy percent are set as initial values for FDR_{low}, and FDR_{high}. The entire RSSI region is then divided into three segments, with a first segment for RSSI values for an FDR less than FDR_{low}, a second segment for RSSI values between FDR_{low} and FDR_{high}, and a third segment for RSSI values for an FDR greater than FDR_{high}. As more data is obtained, FDR_{low}, and FDR_{high} can be adjusted.

For all measured FDR and corresponding RSSI values, linear fitting is accomplished by first establishing RSSI₁₀, as the largest RSSI value that is less than the smallest measured RSSI on which FDR is greater than FDR_{low}, then establishing RSSI_{high} as the smallest RSSI value that is greater than the largest measured RSSI on which FDR is less than FDR_{high}, and then employing a least-square linear fitting algorithm to estimate the FDR for each segment. That is, data points where RSSI is less than RSSI_{low} are used to estimate all FDR values with RSSI less than RSSI_{low}, etc. FIG. 5B shows a sample three-segment linear fitting to FDR values 401-403 shown in FIG. 4. The values determined in this fashion may then be used to populate the environment table. For example, the values for segments 404-407 (i.e., the FDR for corresponding RSSI values) may be stored in the environment table.

It should be appreciated that a least-square linear fitting algorithm is only one of many ways of estimating a metric for a particular transmission, and that the invention is not limited to this or any particular technique. Further, where the metric to be estimated is FDR, the technique need not employ a relationship between FDR and RSSI, as any one or more factors may alternatively or additionally be employed. For example, a relationship between FDR and frame size, or between FDR and any other factor(s), may be employed. The invention is not limited to being implemented in any particular fashion.

In some embodiments, the values in the environment table may be periodically updated to reflect changes in channel conditions. For example, estimated FDR values for a particular data rate and frame size (as illustrated above in FIGS. 4 and 5A-5B) may be updated when certain conditions are satisfied. For example, when an FDR value is measured for a data transmission rate, frame size and RSSI, it may be used to update whatever FDR value (e.g., an estimated value) is currently stored in the environment table.

In another example, a measured FDR value may be used to update the environment table when it varies dramatically from a previously measured FDR value for a particular data transmission rate, frame size, and RSSI. Whether a change is sufficiently dramatic may be determined using any of numerous criteria, such as whether the difference between the current value and the last measured value is greater than a particular threshold. A threshold may be defined using any suitable technique.

In some embodiments, a dramatic change to a previously measured FDR value may initiate a probe of other rates, to determine whether channel conditions have changed significantly. For example, a dramatic change may cause probing to be initiated to determine FDR values at multiple data transmission rates. Probing may be initiated for other reasons as well. For example, if the FDR value for a particular data transmission rate, RSSI and frame size remains the same for more than a predefined period, probing may be initiated. Any suitable criteria may initiate probing, as the invention is not limited in this respect.

Probing may last for any suitable period, as the invention is not limited in this respect. For example, a probe may last for a predetermined interval, an amount of time required to transmit a predetermined number of frames, one or more other intervals, or a combination thereof. Probing may be online (i.e., data frames which are delivered), offline (i.e., using internally generated test frames), or a combination thereof.

In some embodiments, a measured FDR value has a decreasing impact on the estimation of FDR values as time elapses. For example, a weight value α having a value between zero and one may be used to balance old and newly measured FDR values. For example, for each data rate, RSSI and frame size, two variables Nₒᵥₑᵣₐₗₗ and N_{success} may be used to aggregate all FDR values measured at different times. For each interval t_{buffer}, the two variables may be computed as follows:

Nₒᵥₑᵣₐₗₗ=(1−α)Nₒᵥₑᵣₐₗₗ+α(number of transmitted frames in current buffer)

N_{success}=(1−α)N_{success}+α(number of successfully transmitted frames in current buffer)

The FDR value for each time interval may then be calculated as

$$FDR = \frac{{N}_{success}}{{N}_{overall}} .$$

Using this technique, the contribution of data measured at a given time interval t_{buffer} is multiplied by (1−α) for each elapsed time interval, and the weight of the history data can be controlled by setting the value of α. That is, when α is close to 1, historical data is discarded, and so the algorithm is highly responsive to changes in channel conditions. When α is close to 0, the algorithm gives historical data more weight, thus generating a more stable environment table. The value for a may be selected in any suitable fashion.

Once the environment table containing one or metrics (in the example above, FDR, although any number and type of metric(s) may alternatively be employed) is constructed, one or more transmission parameters may be selected to optimize the considered metric(s). Using the examples described above to illustrate, if the metric to be optimized is FDR and the transmission parameter is the data transmission rate, then a data transmission rate may be selected which will optimize the expected FDR for a given frame size and RSSI. Of course, as described above in Section I, FDR is only one example of a metric to be optimized, and the metric to be optimized may depend on the transmission type. For example, if the transmission includes VoIP traffic then the metric to be optimized may be FDR, and if the transmission includes file transfer traffic then the metric to be optimized may be throughput, which may be derived using FDR. The transmission parameter(s) may be selected on a per-packet basis, per-packet-group basis, or on any other suitable basis.

Some embodiments may pre-calculate certain values to reduce computational overhead. For example, in some embodiments, RSSI may be estimated at the beginning of each time interval t_{buffer}, and the FDR may be estimated for each data rate and frame size increment. An optimal transmission rate may then be determined to maximize one or more metrics (e.g., FDR, throughput, etc.) When a transmission is to be made, the transmission type may be determined, and based on this type the optimal transmission rate may be selected to optimize the metric(s) associated with that type.

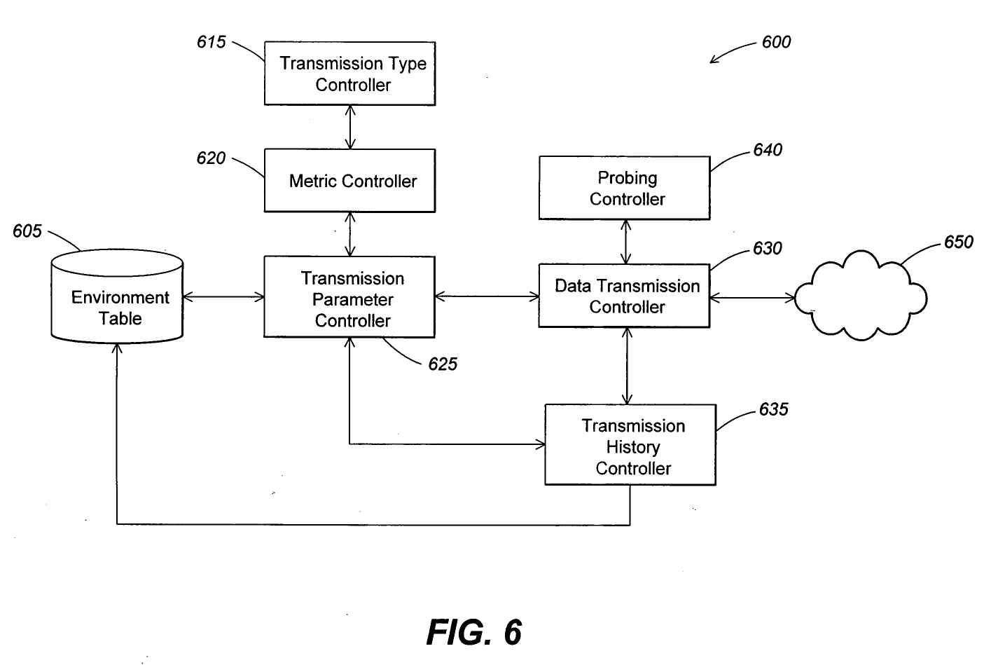

FIG. 6 depicts an example system 600 including components for performing various functions described above. In some embodiments, the system of FIG. 6 may be implemented via a wireless network interface card. However, the invention is not limited to such an implementation. For example, the system of FIG. 6 may be implemented via a wireless radio, which may comprise a hardware and/or software elements.

FIG. 6 depicts a system which includes components for selecting one or more transmission parameters based at least in part on channel conditions and/or transmission type. System 600 includes environment table 605, which may, for example, be initialized, constructed and/or maintained using the techniques described above.

In this example, transmission type controller 615 determines a type for the transmission. This determination may be made in any of numerous ways, such as by using the techniques described above, as the invention is not limited to any particular technique. For example, in some embodiments, the type of transmission is determined based on an indication (e.g., provided in the transmission itself) of the transmission's content.

Metric controller 620 communicates with transmission type controller 615 and determines one or more metrics to be optimized for the transmission. This determination may, for example, be made using the techniques described above. For example, one or more metrics to be optimized may be defined for each type of transmission.

Transmission parameter controller 625 communicates with metric controller 620 and accesses environment table 605. That is, transmission parameter controller 625 may receive an indication of the metric(s) to be optimized for the transmission, access environment table 605 to determine the channel conditions along one or more dimensions, and select a transmission parameter to optimize the metric(s) given the channel conditions. Using one of the examples given above to illustrate, if transmission type controller 615 determines that the transmission contains VoIP traffic, and metric controller 620 determines that the metric to be optimized for VoIP traffic is FDR, then transmission parameter controller 625 may access environment table 605 to ascertain the channel conditions and select one or more transmission parameters. For example, transmission parameter controller 625 may determine the frame size and RSSI (as discussed further below) for the transmission, and select a data transmission rate which is expected to optimize (e.g., maximize) the FDR for the transmission.

Once the data transmission parameter(s) is (are) selected, data transmission controller employs the parameter(s) to perform the transmission on wireless network 650. This transmission may be performed in any of numerous ways, and embodiments of the invention are not limited to any particular technique, protocol, and/or other transmission characteristics.

Upon the transmission being performed, transmission history controller 650 stores an indication of the parameter(s) used for the transmission. In addition, transmission history controller 650 may receive an indication from data transmission controller 630 (e.g., as a result of a reply to the transmission being received by data transmission controller 630) as to whether the transmission was successful. Transmission history controller 635 may employ this information to update environment table 605 (e.g., by calculating the FDR for a particular RSSI and frame size, and loading the FDR value to the table). In addition, transmission history controller 635 may provide an indication of RSSI to transmission parameter controller 625, which may employ this indication in accessing environment table 605.

Data transmission controller 630 also takes input from probing controller 640, which in the example shown defines logic for probing. As described above, probing may be initiated if an FDR value for a transmission is outside an expected range, is unchanged over a predetermined time period, or upon any other suitable circumstances. If this occurs, probing controller 640 may provide input to data transmission controller 630 defining logic for issuing probes on network 650. Responses to probes may, for example, be loaded to environment table 605.

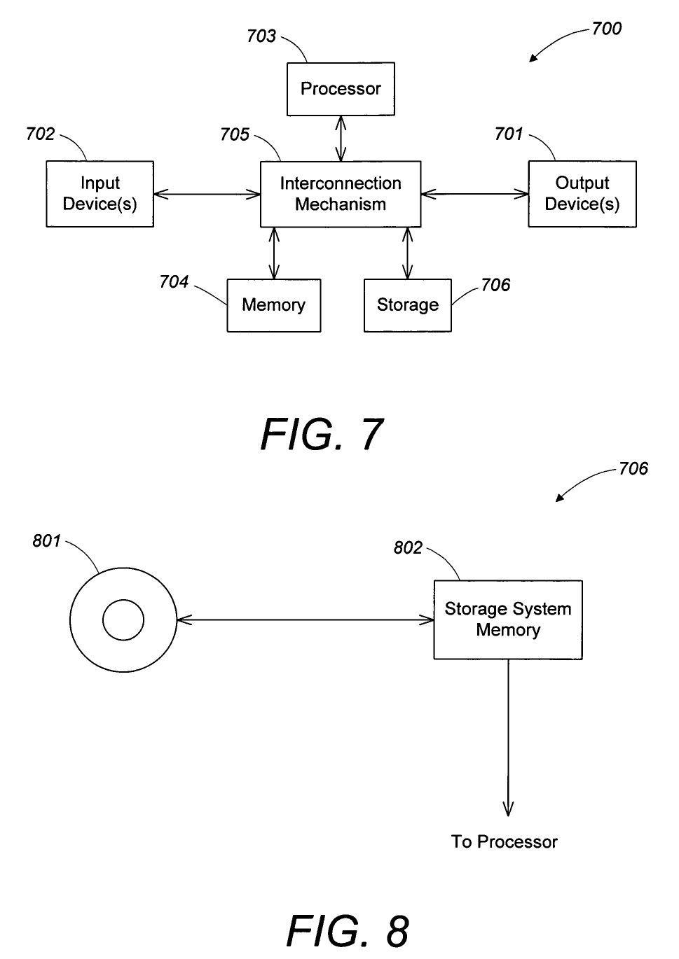

Various aspects of the systems and methods for practicing features of the invention may be implemented on one or more computer systems, such as the exemplary computer system 700 shown in FIG. 7. Computer system 700 includes input device(s) 702, output device(s) 701, processor 703, memory system 704 and storage 706, all of which are coupled, directly or indirectly, via interconnection mechanism 705, which may comprise one or more buses, switches, networks and/or any other suitable interconnection. The input device(s) 702 receive(s) input from a user or machine (e.g., a human operator), and the output device(s) 701 display(s) or transmit(s) information to a user or machine (e.g., a liquid crystal display). The processor 703 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

The processor 703 may also execute one or more computer programs to implement various functions. These computer programs may be written in any type of computer program language, including a procedural programming language, object-oriented programming language, macro language, or combination thereof. These computer programs may be stored in storage system 706. Storage system 706 may hold information on a volatile or non-volatile medium, and may be fixed or removable. Storage system 706 is shown in greater detail in FIG. 8.

Storage system 706 typically includes a computer-readable and writable nonvolatile recording medium 801, on which signals are stored that define a computer program or information to be used by the program. A medium may, for example, be a disk or flash memory. Typically, an operation, the processor 703 causes data to be read from the nonvolatile recording medium 801 into a volatile memory 802 (e.g., a random access memory, or RAM) that allows for faster access to the information by the processor 703 than does the medium 801. The memory 802 may be located in the storage system 706, as shown in FIG. 8, or in memory system 704, as shown in FIG. 7. The processor 703 generally manipulates the data within the integrated circuit memory 704, 802 and then copies the data to the medium 801 after processing is completed. A variety of mechanisms are known for managing data movement between the medium 801 and the integrated circuit memory element 704, 802, and the invention is not limited thereto. The invention is also not limited to a particular memory system 704 or storage system 706.

Having thus described several aspects of at least one embodiment of this invention, it is to be appreciated that various alterations, modifications, and improvements will readily occur to those skilled in the art. Such alterations, modifications and improvements are intended to be part of this disclosure, and are intended to be within the spirit and scope of the invention. Accordingly, the forgoing description and drawings are by way of example only.

The above-described embodiments of the present invention can be implemented in any of numerous ways. For example, the above-discussed functionality can be implemented using hardware, software or a combination thereof. When implemented in software, the software code can be executed on any suitable processor or collection of processors, whether provided in a single computer or distributed among multiple computers. In this respect, it should be appreciated that any component or collection of components that perform the functions described herein can be generically considered as one or more controllers that control the above-discussed functions. The one or more controllers can be implemented in numerous ways, such as with dedicated hardware, or by employing one or more processors that are programmed using microcode or software to perform the functions recited above. Where a controller stores or provides data for system operation, such data may be stored in a central repository, in a plurality of repositories, or a combination thereof.

Further, it should be appreciated that a (client or server) computer may be embodied in any of a number of forms, such as a rack-mounted computer, a desktop computer, a laptop computer, or a tablet computer. Additionally, a (client or server) computer may be embedded in a device not generally regarded as a computer but with suitable processing capabilities, including a Personal Digital Assistant (PDA), a smart phone or any other suitable portable or fixed electronic device.

Also, a (client or server) computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms.

Additionally, such software may be written using any of a number of suitable programming languages and/or conventional programming or scripting tools, and also may be compiled as executable machine language code or intermediate code that is executed on a framework or virtual machine.

In this respect, the invention may be embodied as a storage medium (or multiple storage media) (e.g., a computer memory, one or more floppy disks, compact disks, optical disks, magnetic tapes, flash memories, circuit configurations in Field Programmable Gate Arrays or other semiconductor devices, or other computer storage media) encoded with one or more programs that, when executed on one or more computers or other processors, perform methods that implement the various embodiments of the invention discussed above. The storage medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be provided in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for performing a transmission of data on a communications network, comprising acts of:
(A) based at least in part on a type for the transmission, determining at least one metric for the transmission, each metric having a value;
(B) selecting, for each of at least one transmission parameter, a value to be employed in performing the transmission, the selected value for each transmission parameter corresponding to a value for the at least one metric; and
(C) transmitting the data on a communications network in accordance with the selected value for each transmission parameter.

2. The method of claim 1, wherein the communications network is a wireless network.

3. The method of claim 1, wherein the act (B) further comprises selecting the value for each transmission parameter to optimize a value for the at least one metric.

4. The method of claim 3, wherein the act (B) further comprises selecting the value for each transmission parameter to maximize a value for the at least one metric.

5. The method of claim 1, wherein the type for the transmission is selected from a group of transmission types comprising 802.1x, Voice over Internet Protocol (VoIP), file transfer, user datagram protocol (UDP) streaming media, multicast and broadcast.

6. The method of claim 1, wherein the at least one metric is selected from a group of metrics comprising frame delivery ratio and throughput.

7. The method of claim 1, wherein the at least one transmission parameter is selected from a group of transmission parameters comprising data transmission rate, retry count, and forward error correction (FEC) code.

8. The method of claim 1, wherein the transmission is to be performed on a channel, and the method further comprises an act, performed before the act (B), of determining an indication of at least one condition on the channel, and wherein the act (B) comprises selecting, for each transmission parameter, a value to be employed in performing the transmission, the value for each transmission parameter being selected based at least in part on the at least one condition on the channel and the at least one metric.

9. A computer readable medium having instructions recorded thereon which, when executed by a computer, perform a method for performing a transmission of data on a wireless network, the transmission to occur on a channel, the method comprising acts of:
(A) maintaining data relating a metric to at least one parameter reflecting a channel condition and at least one parameter defining a characteristic of a transmission;
(B) determining a value of a channel condition of the at least one channel condition;
(C) based at least in part on the determined value of the channel condition, obtaining from the data a value of a parameter of the at least one parameter defining a characteristic of the transmission; and
(D) transmitting over the channel using the obtained value of the parameter defining the characteristic of the transmission.

10. The computer readable medium of claim 9, wherein the act (C) further comprises obtaining from the data a value which corresponds to an optimized value for the metric.

11. The computer readable medium of claim 10, wherein the act (C) further comprises obtaining from the data a value which corresponds to a maximized value for the metric.

12. The computer readable medium of claim 9, wherein the at least one transmission parameter comprises a data transmission rate, the at least one metric comprises a frame delivery ratio (FDR), and wherein the act (C) further comprises selecting a value for the data transmission rate which corresponds to a maximum FDR value.

13. The computer readable medium of claim 9, wherein the data comprises a plurality of values for the metric, a first portion of the plurality of values comprising measured values and a second portion of the plurality of values comprising estimated values.

14. The computer readable medium of claim 13, wherein the second portion of the plurality of values is estimated using a technique which employs a known relationship between the metric and a channel condition.

15. The computer readable medium of claim 13, wherein the metric is FDR, the channel condition is RSSI, and the parameter is data transmission rate.

16. The computer readable medium of claim 9, wherein the act (A) further comprises maintaining data relating each of a plurality of metrics to a corresponding at least one parameter reflecting a channel condition and at least one parameter defining a characteristic of a transmission.

17. The computer readable medium of claim 16, wherein the plurality of metrics comprises FDR and throughput, and wherein each metric corresponds to a transmission type.

18. A system for performing a transmission of data on a wireless network, the transmission to occur on a channel, the system comprising:
a metric controller operable to receive an indication of a type for the transmission and to determine, based at least in part on the transmission type, at least one metric for the transmission, each metric having a value;
at least one storage element storing an indication of at least one condition on the channel;
a transmission parameter controller operable to:
receive an indication of the at least one metric from the metric controller;
access the at least one storage element to determine at least one condition on the channel; and
select, for each of at least one transmission parameter, a value to be employed in performing the transmission, the selected value for each transmission parameter being selected based at least in part on the at least one condition on the channel and the at least one metric; and
a transmission controller operable to transmit the data on a wireless network in accordance with the at least one transmission parameter.

19. The system of claim 18, wherein the system is implemented via a network interface card.

20. The system of claim 17, wherein the at least one transmission parameter is selected from a group of transmission parameters comprising data transmission rate, retry count, and forward error correction (FEC) code.
